(19) United States
(12) Patent Application Publication
(10) Pub. No.: US 2011/0009181 A1
(43) Pub. Date: Jan. 13, 2011

(54) METHOD OF SEARCHING FOR GAMING DEVICE DISPLAY

(75) Inventors: L. Donald Speer, II, San Diego, CA (US); W. Greg Shay, Las Vegas, NV (US); Kevin McIntosh, San Diego, CA (US); Donne Grable, San Diego, CA (US)

Correspondence Address: MARGER JOHNSON & MCCOLLOM, P.C., 210 SW MORRISON STREET, SUITE 400, PORTLAND, OR, 97204, US

(73) Assignee: VCAT, LLC, San Diego, CA (US)

(21) Appl. No.: 12/501,358

(22) Filed: Jul. 10, 2009

(51) Int. Cl. A63F 9/24; A63F 13/00

(52) U.S. Cl. 463/20; 463/30

(57) ABSTRACT

Embodiments of the present invention are directed to methods for searching for or otherwise identifying particular patterns or outcome trends associated with a gaming device, and gaming systems for implementing these methods. In one example, a gaming system may include a plurality of gaming devices having pattern displays, a server connected to the gaming devices through a network and configured to identify display information from the pattern displays of the gaming devices, and a search device operable by a player to search for desired display information and configured to identify a gaming device having pattern information displayed that substantially matches the desired display information.

### FIELD OF THE INVENTION

This disclosure relates generally to gaming devices, and more particularly to methods of searching for a gaming devices having a particular display, such as outcome based display of summarized past gaming results or a randomly generated display, associated with the gaming device.

### BACKGROUND

With games of chance, gaming players often seek out certain games (including but not limited to slot machines, electronic table games, live action table games, internet games, lotteries, etc.) or game configurations (including but not limited to player positions, dealers, game devices such as card shoes, etc.) or change their behavior based on actual or perceived patterns or trends the players believe they see related to a game, a game configuration, or a player. The patterns or trends that are likely to influence their behavior can be based on game or player outcomes and can be applicable to the game type, gaming device, game location, player position, game configuration, etc. Alternatively, these patterns or trends may be perceived symbols, signs, or objects associated with a gaming device or aspect of a gaming device. These patterns or trends can influence player behavior in many ways, including a decision to play or not, the game type and/or location of the game they choose to play, the wager amount, etc. Behavior influence is often times attributable to the player's belief that future outcomes are, or will be, more predictable based on actual or perceived patterns or trends.

Currently, players may select a gaming machine to play by its theme, availability, and location or proximity to certain casino areas. When presented with a bank of similar games, all of which are available, a player may select a device based on how lucky he or she perceives the gaming device. For example, rumors exist that casinos often place higher paying machines at the edges of rows or banks so that the increase in winning outcomes is more visible to other players who may be influenced to play the game as well. Whether or not this rumor is true, it can affect a player's decision on which gaming device to choose. Other influencing factors may include the last game outcome shown on the gaming machine, how large the “cash-out” value of the last player was, the colors associated with the gaming device, etc. For table games, players may select a certain table or position at a table based on other observations. For example, they may look to the attitude of other players at the table, the demeanor of the dealer, the positions open at the table, etc.

As discussed in patent application Ser. No. 12/398,889 entitled “OUTCOME BASED DISPLAY OF GAMING RESULTS” and patent application Ser. No. 12/398,911 entitled “RANDOM GENERATED DISPLAY ASSOCIATED WITH GAMING DEVICE,” both of which are hereby incorporated by reference, the patterns or trends that players may be seeking can vary widely. Often times the patterns or trends they are seeking are simple. For example, a player might try to determine what games or game configurations have been good for the player, or alternatively bad for the player and good for the “house”. The range of outcomes they consider when making this determination can also vary widely. The player might be interested in knowing this for: past outcomes over a very short to a very long period of time; for a small to wide number of past outcomes; for a specific session or sessions; for a specific player; for a specific position; for specific configurations, etc. Alternatively, since players can also be influenced by other “signs” that the player sees and associates with lucky or unlucky past experiences, they may be interested in finding displays of patterns that conform with these signs. A sign can simply be that a player believes in a lucky number, symbol, date, color etc. It can also involve their belief that someone or something else is lucky, such as another player, a dealer, a location, a device, etc., which becomes associated with the sign they see.

Thus, it is likely that player behavior and the decisions they make are, and can be further influenced by patterns or other signs the players believe they see. However, if a player has had particularly good luck in the past with a gaming device displaying a certain pattern or trend of past outcomes, or if a player is particularly interested in playing a gaming device with such displays, the player may spend a considerable amount of time searching a gaming floor for a gaming device with that particular pattern or outcome trend. This searching process can be both frustrating to the player and disadvantageous to the casino. For the player, excessive searching may become tiresome, and even if they identify a gaming device with a particular desired pattern or trend, another player may be occupying the gaming station. For the casino, when a player is searching for a particular device instead of placing wagers, the casino is not generating any profit. Hence, in conjunction with the benefits associated with enhancing the player experience by presenting patterns or outcome trends with games, it is desirable to provide a method of searching for or otherwise identifying gaming devices that are displaying patterns or outcome trends of particular interest to a player.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, 2C, and 2D are detail diagrams of exemplary types of gaming devices according to embodiments of the invention.

FIG. 3 is a functional block diagram of networked gaming devices according to embodiments of the invention.

FIG. 4 is a functional block diagram of a gaming system according to embodiments of the invention.

FIG. 5 is a diagram of elements of a gaming system according to embodiments of the invention.

FIGS. 6A, 6B, and 6C are detail diagrams of exemplary types of displays for displaying pattern search information according to embodiments of the invention.

FIG. 7 is a detail diagram of a gaming device according to embodiments of the invention.

FIG. 8 is a flow diagram illustrating methods of identifying a gaming device for a player according to embodiments of the invention.

FIG. 9 is a flow diagram illustrating methods of identifying a player-preferred pattern according to embodiments of the invention.

FIG. 10 is a flow diagram illustrating methods of notifying a player of a substantially matching pattern according to embodiments of the invention.

FIG. 11 is a flow diagram illustrating methods of locating an identified gaming device for a player according to embodiments of the invention.

FIG. 12 is a flow diagram illustrating methods of remote wagering on an identified gaming device for a player according to embodiments of the invention.

FIG. 13 is a flow diagram illustrating methods of identifying a gaming device for a player according to embodiments of the invention.

### DETAILED DESCRIPTION

As discussed above, methods for searching for or otherwise identifying particular patterns or outcome trends associated with a gaming device, and gaming systems for implementing these methods are desirable to assist players in identifying gaming devices with particular displays of outcome trends or patterns that are associated with the gaming devices. Displayed outcome trends or patterns include all of the game performance data, trend information, and pattern displays discussed in patent application Ser. Nos. 12/398,889 and 12/398,911, which will collectively be referred to in this disclosure as pattern display information or patterns.

In one example, these methods include identifying pattern display information that is preferred by a player, accessing pattern display information for a plurality of gaming devices, comparing the player-preferred pattern display information to the accessed pattern display information for the gaming devices, and notifying the player when one or more gaming devices have pattern display information that substantially matches the player-preferred pattern display information. In another example, a gaming system may include a plurality of gaming devices having pattern displays, a server connected to the gaming devices through a network and configured to identify display information from the pattern displays of the gaming devices, and a search device operable by a player to search for desired pattern display information and configured to identify a gaming device having pattern display information displayed that substantially matches the desired pattern display information.

As discussed below, these search methods and systems may be used actively by players looking for particular gaming devices on a gaming floor to play, or may be run passively to notify players when a gaming device on the gaming floor has pattern display information that substantially matches identified player-preferred pattern display information for the players. Additionally, once a gaming device has been identified for a player, these methods and systems may help the player locate the gaming device on the gaming floor so that the player can play the identified gaming device, or may provide the player with an opportunity to play the identified gaming device remotely.

By providing these methods and gaming systems, players may feel more connected to their gaming experience and feel that the choices they make have an effect on their gaming sessions because they are able to find gaming devices having specific pattern display information that may be associated with a past jackpot win, a lucky symbol or sign, a promising trend, or the like. This in turn can heighten the gaming experience for the player and may increase player gaming time by notifying players of gaming devices that match player-set criteria. Since this system can be used for all types of electronic gaming devices, such as slot machines and video poker machines, as well as being used for table games (live action or automated table games), lotteries, internet gaming systems, mobile gaming devices, etc., players may have many options in setting preferences and receiving data on pattern display information.

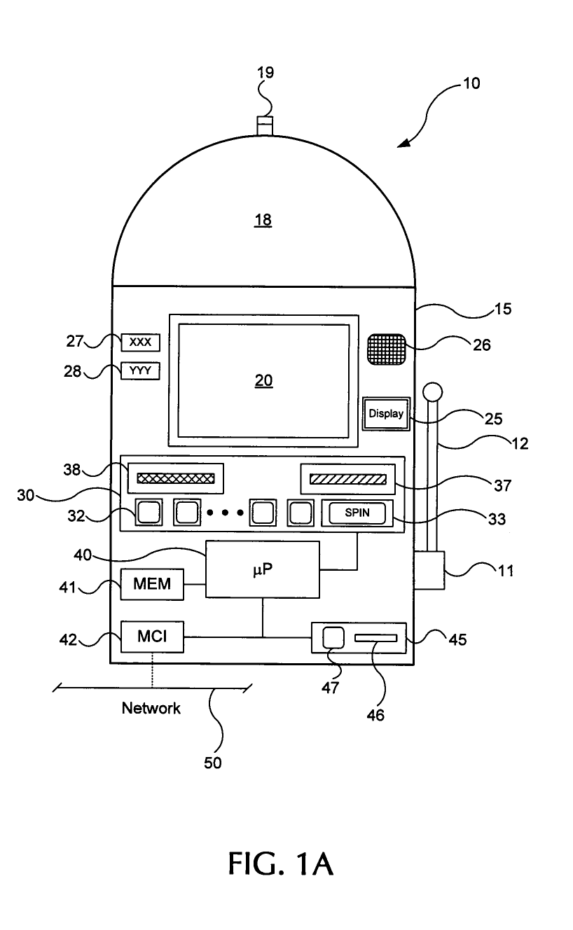

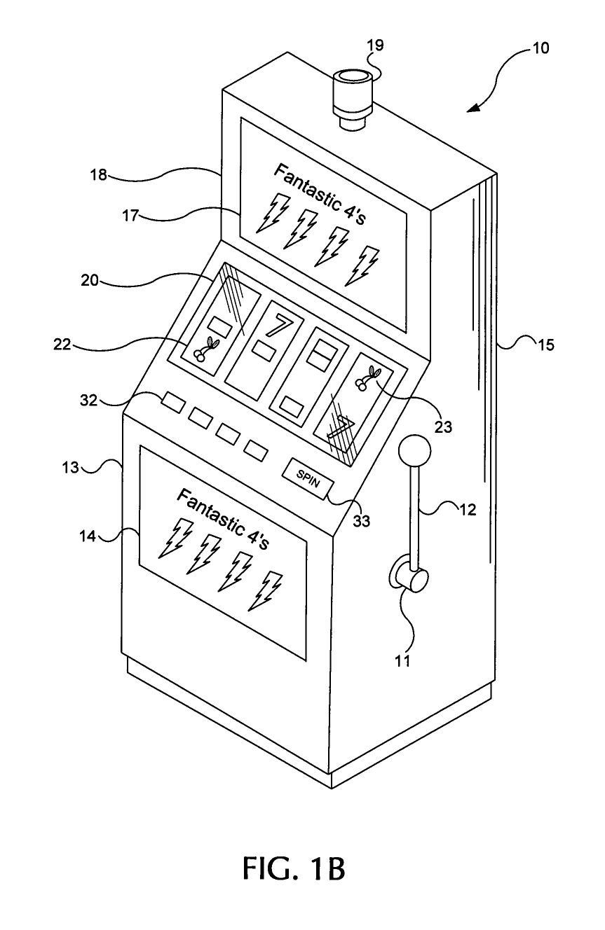

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electro-mechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, lottery devices, and other similar devices. Although embodiments of the invention will work with all of the gaming types mentioned, for ease of illustration the present embodiments will be described in reference to the electronic gaming machine 10 shown in FIGS. 1A and 1B.

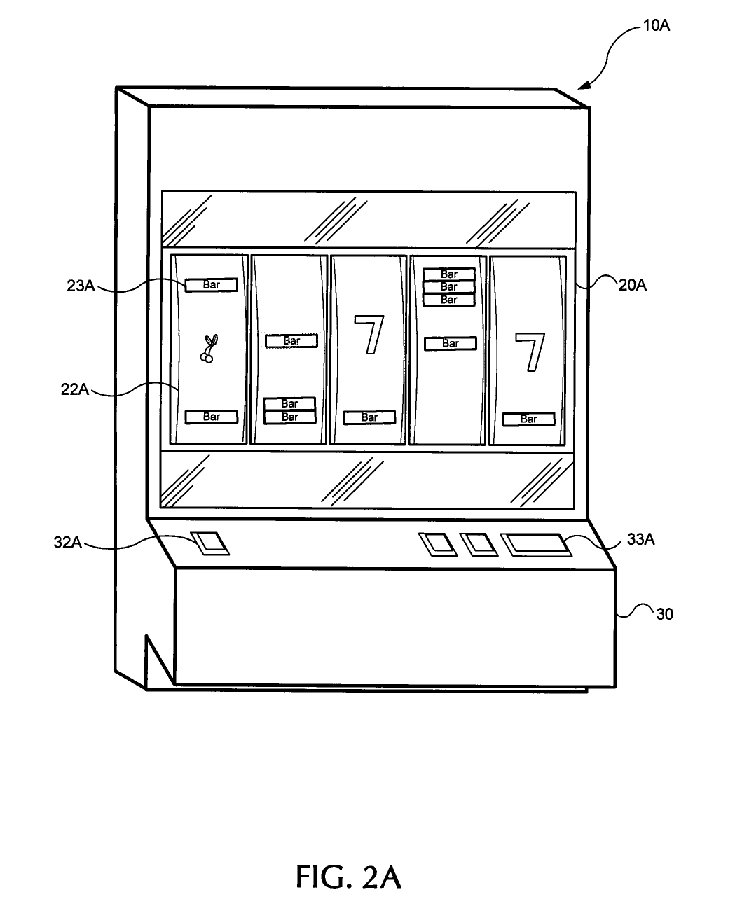

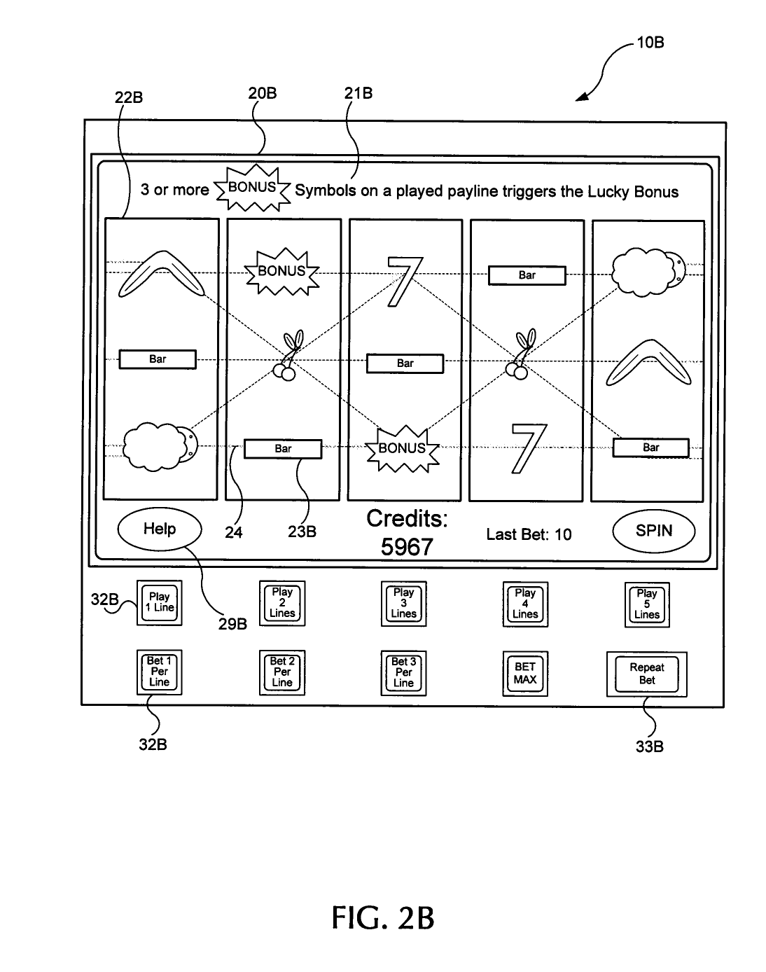

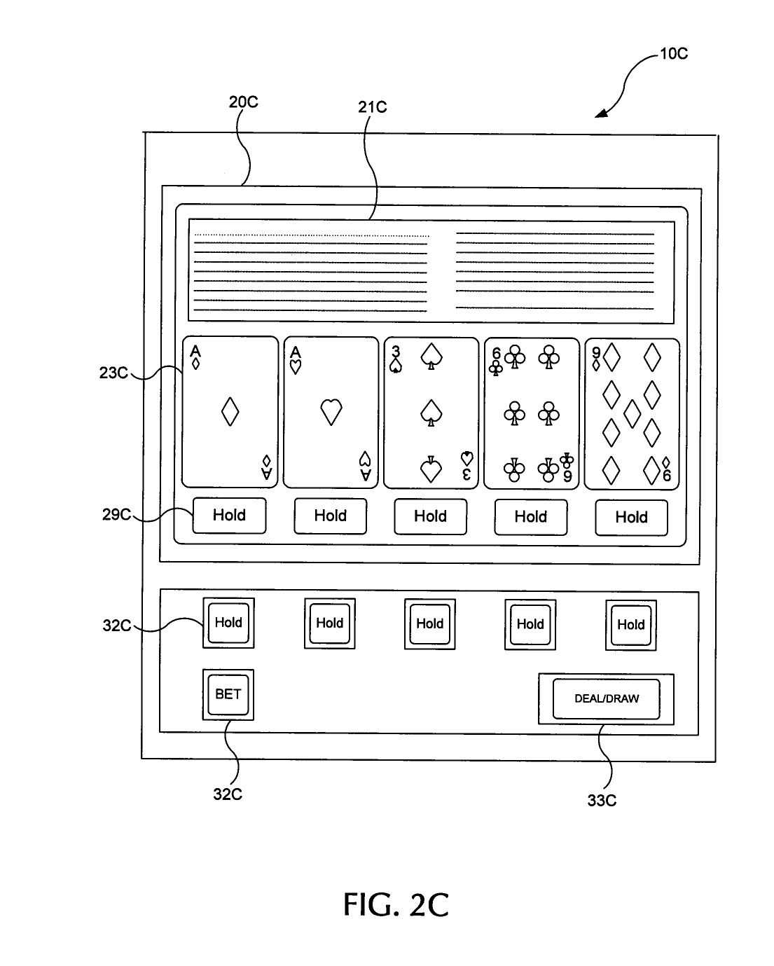

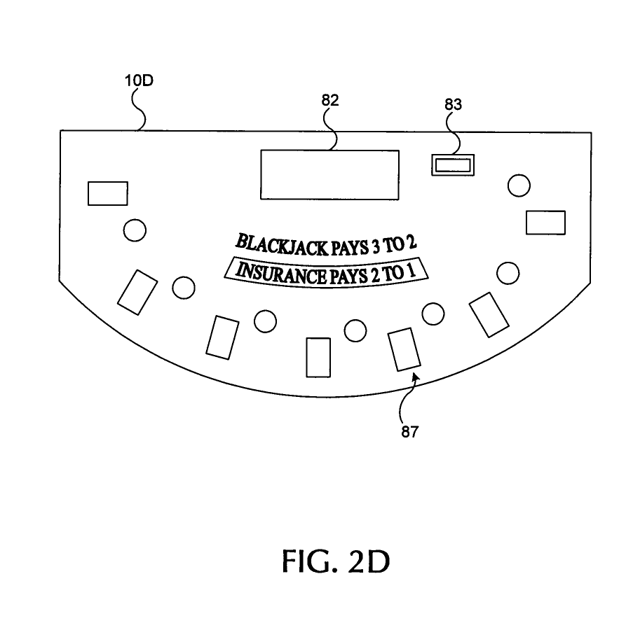

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show any combination of primary game information and ancillary information to the player. For example, the secondary display 25 may show player tracking information, secondary bonus information, advertisements, or player selectable game options.

The gaming device 10 may include a separate information window (not shown) dedicated to supplying any combination of information related to primary game play, secondary bonus information, player tracking information, secondary bonus information, advertisements or player selectable game options. This window may be fixed in size and location or may have its size and location vary temporally as communication needs change. One example of such a resizable window is International Game Technology's “service window”. Another example is Las Vegas Gaming Incorporated's retrofit technology which allows information to be placed over areas of the game or the secondary display screen at various times and in various situations.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicating with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

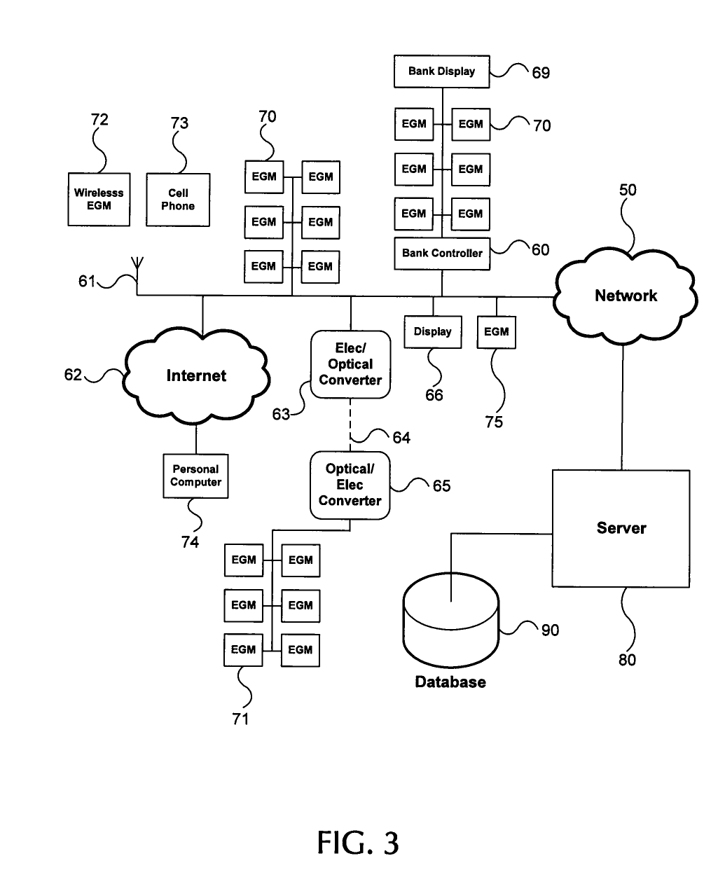

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit, debit or casino account card into a card reader/authorizer (not shown). One of skill in the art will readily see that this invention is useful with all gambling devices, regardless of the manner in which wager value-input is accomplished.

The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2D illustrate exemplary types of gaming devices according to embodiments of the invention. FIG. 2A illustrates an example spinning-reel gaming machine 10A, FIG. 2B illustrates an example video slot machine 10B, FIG. 2C illustrates an example video poker machine 10C, and FIG. 2D illustrates an example blackjack table game.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines and various other types of gaming devices known in the art are contemplated and are within the scope of the invention.

Referring to FIG. 2D, a blackjack table 10D includes a dealer position 82, a plurality of player positions 87, and a gaming medium 83. For the blackjack table 10D shown in FIG. 2D, the gaming medium may be a deck of cards or a shoe including one or more decks of cards. The blackjack table 10D may also include an automatic card shuffler (not shown). The blackjack table 10D may be a “live action table,” an “electronic smart table,” or a combination of the two. A live action table may include a person as the dealer that manages the betting and game play at the table 10D. An electronic smart table may include a simulated dealer and video screens (not shown) at each player position 87 to facilitate wagering and game play. A combination table may include a person as a dealer, but have electronic elements associated with each player position, such as player ID input devices, video monitors, electronic input devices, etc. (not shown) to augment game play.

Although a blackjack table is shown in FIG. 2D, any type of table gaming device may be used, such as roulette, pai gow, craps, baccarat, poker, etc. Although some aspects of these tables may vary from the blackjack table shown in FIG. 2D, the basic principles of these tables are well known in the art, and thus do not require additional explanation. Embodiments of the present concept contemplate use with all of these types of gaming devices.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, Rs-232 lines, firewire lines, USB lines, or other communication protocols. Although not shown in FIG. 3, substantially the entire network 50 may be made of fiber optic lines or may be a wireless network utilizing a wireless protocol such as IEEE 802.11 a, b, g, or n, Zigbee, RF protocols, optical transmission, near-field transmission, or the like.

Gaming displays 66, 69 may also be connected to the server 80 through the network 50. These displays 66, 69 may be common gaming displays that show game information relating to multiple gaming devices 70-75, such as linked bonuses, multiple game station outcomes, or the like. Alternatively, the displays 66, 69 may show promotional casino information, advertisements, or other information that is to be communicated to players. The displays may be stand alone displays 66 directly connected to the network 50 or bank displays 69 connected to the network 50 through a bank controller 60.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records in the player database 90 to provide the player with information regarding their player account or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses or extra benefits such as bonus games and other benefits as described above. These added benefits further entice the players to play at the casino that provides the benefits.

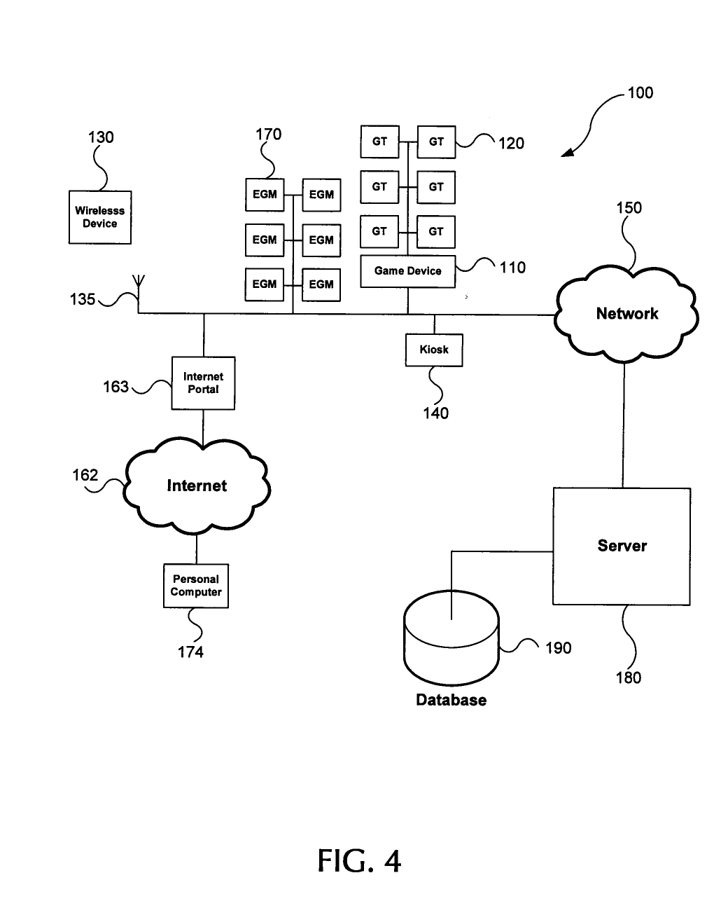

FIG. 4 is a functional block diagram of a gaming system according to embodiments of the invention.

Referring to FIG. 4, a gaming system 100 includes a network 150 connecting a plurality of gaming devices 170 with a server 180. Additionally, a gaming device 110 having a plurality of associated game terminals 120 may be connected to the network 150. The gaming system 100 may also include an internet portal 163, which connects the network 150 to the Internet 162. Also connected to the Internet may be many personal computing devices 174 as described above with respect to FIG. 3. A player kiosk 140 may further be connected to the network 150. An antenna 135 may also be connected to the network 150 so that wireless devices 130 may be in contact with other devices connected over the network 150. Unless specifically noted, the term gaming device 170 refers generically to all types of gaming devices and includes gaming devices 110 having associated game terminals, as well as remote game devices, wireless game devices, etc. as described above. The wireless device 130, kiosk 140, and personal computer 174, as well as various other devices that perform similar searching or identifying functions as these devices, including gaming devices that are configured to allow searches of other game devices, may generally be referred to as search devices. In other words, search devices include any device that is operable by a player to search for desired pattern display information and configured to identify one or more gaming devices that have pattern display information displayed substantially matching the desired pattern display information.

The gaming system 100 is configured at least in part to identify or search for gaming devices having an associated pattern displayed that may of interest to a player. The gaming system 100 may accomplish this object in a variety of ways. As discussed below, the gaming system 100 may be configured to be used actively by players looking for particular gaming devices 170 on a gaming floor to play, or may be run passively to notify players when a gaming device 170 on the gaming floor has pattern display information that substantially matches identified player-preferred pattern display information for the players. Additionally, the gaming system may be further configured to help the player locate the identified gaming device 170 on the gaming floor, or allow the player to remotely play the identified gaming device 170.

For embodiments where the gaming system 100 is configured to be used actively by a player searching for a specific pattern or a particular type of gaming device 170 having a specific pattern, the server 180 may not access and gather pattern display information from the gaming devices 170 until a request is received from the player to search for a particular pattern. Alternatively, the server 180 may be configured to periodically access and gather pattern display information from the gaming devices 170 so that it can provide the player with search results faster. In other embodiments, the gaming system 100 may use a combination of the above two techniques to provide fast and up to date searches. For example, in a combination configuration, the gaming server 180 may periodically update stored pattern display information for the gaming devices and also note which gaming devices are being played. When a player search request is received the gaming server 180 may only access pattern display information from gaming devices 170 that were indicated as being played during the last periodic pattern display information gathering (since those games may be the most likely ones with changes to the displayed patterns). Alternatively, the gaming server 180 may identify a most similar pattern from the stored patterns and then access the gaming device having the identified similar pattern so that it can display the most up to date variation of the pattern. While the above example embodiments provide some of the possible configurations for the game system 100, various other configurations of the game system 100 not discussed above are also contemplated by this concept.

Players may actively search for gaming devices 170 with a specific pattern and/or of a particular type in a variety of situations. For example, a player may have entered the game floor of a casino and want to find a preferred game device 170 to play, or simply want to find a new game device 170 while on the game floor. To accomplish this, a player may use a wireless device 130 that can communicate to the server 180 over the network 150 through an antenna 135. A player may also use a kiosk 140 connected to the server 180 through the network 150 to actively search for gaming devices 170. Kiosks 140 may be located at various locations on the game floor and around the casino, or may be included at other possible player interface points, such as at airports, convention halls, other commonly-owned casinos, etc. Players may also perform searches from game devices 170 themselves. For example, a player may become tired of playing video poker on a gaming device and want to look for a Wheel of Fortune® slot machine that has a desirable pattern display. Here, the player may be able to briefly use the video poker machine to search for a desirable pattern on one of the Wheel of Fortune® slot machines.

In other examples, the player may be remotely looking at the present patterns of the game devices to decide if they want to travel (from their hotel room or another location) to the game floor to play a gaming device or to remotely play a gaming device 170. The player may again utilize a wireless device 130 or a remote kiosk 140 to perform this search. A personal computer (or other computing device) 174 connected to the game network 150 through an internet portal 163 and the Internet 162 may also be used by the player to actively search for a gaming device 170 having a particular pattern.

When actively searching for a particular pattern display, the gaming server 180 may be configured to identify only a single pattern display that best matches the search criteria provided by the player, or may provide a list or menu of pattern displays matching the player's search criteria. Identifying only a single pattern display may be preferable in some situations because it simplifies the search process for the player and may increase the time the player is actually playing the gaming devices. Additionally, if the player has a particular pattern or trend saved and wants to find an active pattern that most closely resembles that saved pattern, identifying a single gaming device having the most similar pattern may provide the player the results they want without further complicating the search process. Determining a most similar pattern display is discussed below with respect to FIG. 8.

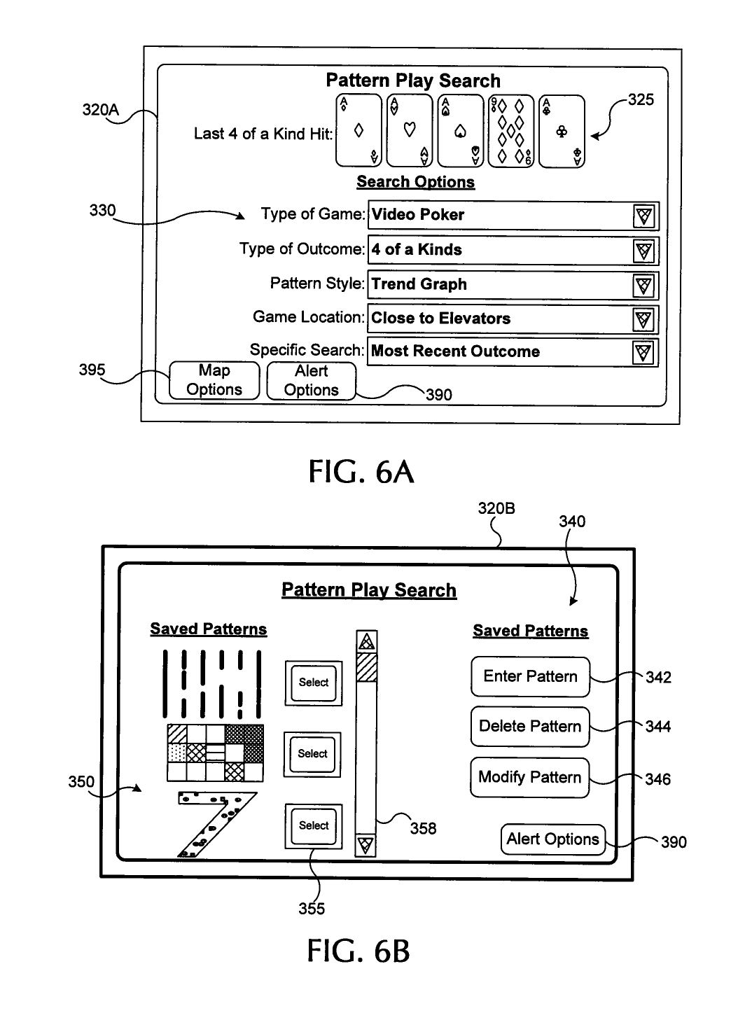

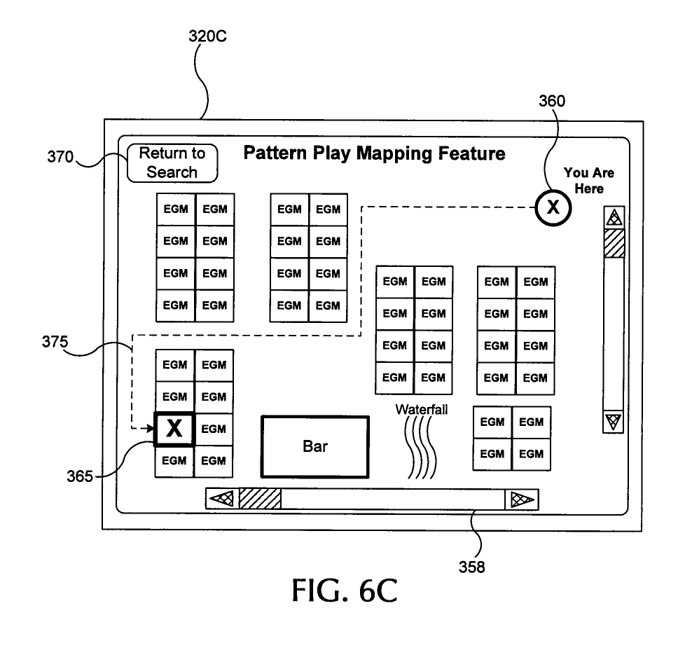

On the other hand, providing a list or menu of several game devices that match a player's request may be preferable in some circumstances because it better simulates the player actually observing the pattern displays for the plurality of game devices. Also, if the player is using general search terms, providing a list or menu of pattern displays may be advantageous because it may be difficult to identify a best match. For example, if the player searches for video poker machines that have not had a four of kind hit in the past 1000 hands played, several gaming devices might match these search parameters. By displaying a list or menu of pattern displays associated with these identified gaming devices the player may be able to select the most preferable one of these devices to play. This selection may be based on factors such as location of the gaming devices, denomination of the gaming devices, whether the identified devices are currently being played by another player, or any other trend or pattern feature shown in the pattern display but not reflected in the search parameters. Lists and menu displaying options are discussed below in additional detail with respect to FIGS. 6A and 6B.

For game devices 110 that have one or more game terminals 120 connected to the gaming device 110, a player at one of the game terminals 120 may be back betting on a player or aspect of the game device 110. For example, gaming device 110 may be a baccarat table that includes a pattern display displaying various game performance information (such as banker and player wins) or random image patterns. The game terminals 120 may be used by other players to back bet on certain players, certain outcomes, or other possible wagers. The game terminals 120 may physically overlook the baccarat table 110 (e.g., stadium seating), or the game terminals 120 may include displays having direct video or another graphical representation of the games taking place on the baccarat table 110. The game terminals may also include a player interface panel with player input devices and a player identification device similar to ones shown on the game devices in FIGS. 1A and 1B. These features may allow the player to monitor game events occurring on the game device 110 as well as being able to place wagers on the game events. Additionally, the displays (not shown) on the game terminals 120 may allow players to monitor patterns and trends with respect to the play occurring on the game device 110. The players may also search for patterns or trends associated with the game device 110. For example, a player at one of the game terminals 120 may be monitoring overall outcomes at the game device (for the baccarat table example, the player may be monitoring the number of banker wins, player wins, and ties), and then decide to search patterns or trends corresponding to each of the present players at the gaming device 110. These patterns or trends may determine how the player at the gaming terminal 120 places his or her wagers.

In other embodiments, game terminals 120 may be connected to a plurality of game devices 110 to allow players at the game terminals 120 to search among the connected game devices for patterns or trends they find lucky or desirable. The player may back bet or otherwise place wagers on an aspect of a gaming device having the identified pattern associated with it. For example, a gaming terminal 120 may be connected to and configured to monitor play of a plurality of blackjack tables 110. A player at the gaming terminal 120 may search for the game performance of each of the dealers at the connected blackjack tables 110 to decide on which of the dealers they would like to place lay bets (betting with the house).

For embodiments where the gaming system 100 is configured to be used passively to monitor the pattern display information displayed on the gaming devices 170 and alert the player when a particularly desirable pattern is displayed on one or more of the gaming devices 170, the gaming server 180 may be configured to periodically access and gather pattern display information from the plurality of connected gaming devices 170 and compare the gathered pattern display information to a player-specified desirable pattern. Alternatively, the game server 180 may publish a player-specified desired pattern to the plurality of connected gaming devices 170, have each gaming device 170 perform a comparison between its current pattern display and the published desirable pattern, and wait for a notification from one or more of the gaming devices 170 of a substantial match between the pattern display information displayed on the gaming device and the published desirable pattern.

Passive monitoring may be requested by a player through a player club account option or used by the casino for marketing purposes. The player may specify a particular form of notification such as an email, text message, tweet, room call, or other rapid communication system designed to alert the player of the substantially matching pattern. The desired form of notification may be selectable and/or dependent on the present activity or location of the player. For example, a player may specify that they are not to be contacted during hours of work or sleep, may be contacted by text messages between the hours of 7:00 PM and 10:00 PM when they are at home, and contacted with a room call when they are vacationing at the casino.

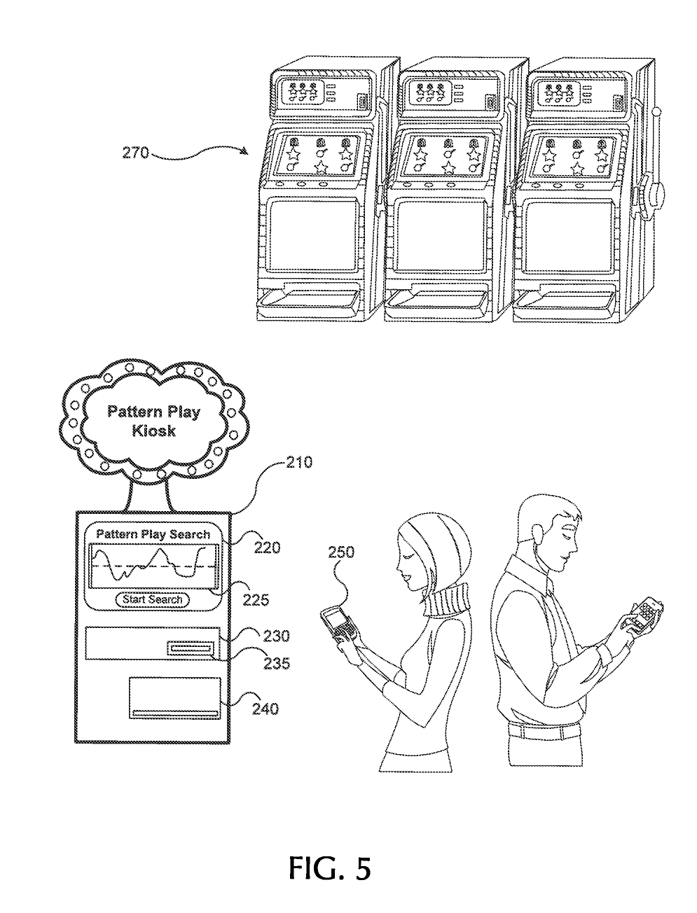

FIG. 5 is a diagram of elements of a gaming system according to embodiments of the invention. In particular, FIG. 5 illustrates several search devices that may be operable by a player to search for a desired pattern display among the plurality of gaming devices. Referring to FIG. 5, these search devices may include a player kiosk 210 or wireless devices 250. As discussed above, players may use other types of search devices, such as gaming devices, home computers, in-room monitors, etc. to find and keep track of specific patterns. Player kiosks 210 and wireless devices 250 may provide more beneficial help to players when they first enter a gaming floor or casino. This is in part because kiosks 210 may be positioned around and/or on gaming floors to facilitate quick searches by players who may wish to find a different gaming device 270 having a desirable pattern display associated with it. Wireless devices 250 may be even more convenient for players to use since they may accompany the players and be used at any time to search for or identify a new gaming device 270.

Player kiosks 210 may include a display 220, a player interface panel 230, and a printer 240. The player kiosk displays 220 may be configured to show pattern search options, configured to identify specific pattern parameters, or configured to display various current patterns 225 from the plurality of gaming devices 270 on the gaming floor. The player interface panel 230 may include various buttons or switches (not shown) and a player card reader 235. The various input devices, such as the buttons or switches, may be used by players to manipulate data shown on the display 220 or to perform other functions associated with searching for specific gaming devices. The player card reader 235 may be used to identify the player, so that the player kiosk 210 can access information about the player that may be remotely stored. For example, if a player wants to find a video poker game where a 4 of a kind has not hit in the last 4000 games, the player may simply identify herself to the player kiosk 210 through the player card reader 235 and let saved search parameters from her player account set the guidelines for searching the pattern displays of the plurality of gaming devices 270. Alternately, the player may be able to use the player interface panel 230 to enter or modify search guidelines.

Because player kiosks 210 are typically fixed to one location in the casino, it may be preferable to include a printer 240 with the player kiosk 210. The printer 240 may be used to print off a map of the gaming floor so that a player can navigate themselves or others from their current location to the location of a gaming device having a desirable pattern display. The printer 240 may also allow the player to print off saved patterns associated with the player's account, or print a variety of other information for the player.

Wireless devices 250 may include similar features to the ones described above for the kiosk 210. In particular, the wireless devices 250 may include a display and a player interface panel configured to allow the player to navigate through saved patterns, to enter or modify search terms, and to be shown directions to a gaming device 270 having an identified pattern displayed. Because wireless devices 250 are typically mobile and can be carried by the player, they may give the player updated directions to a gaming device based on the player's current location. Additionally, if a player becomes tired of a particular gaming device and wants to search the pattern display information of other gaming devices on the gaming floor, a wireless device 250 may be preferable to a searches on a player kiosk 210 or searches on the gaming device itself because a player will either have to locate the player kiosk 210 to perform a subsequent search or take away possible gaming time on the gaming device to perform a subsequent search.

Wireless search devices 250 may be specialized wireless devices handed out to players by a casino that can only be used within that casino or another commonly owned or cooperating casino. These specialized wireless devices may also allow a player to remotely play an identified gaming device or back bet on another player at an identified gaming device. However, other types of wireless devices such as cell phones, PDAs, or other types of personal wireless devices may be used as long as they are configured to communicate with the network 150 (FIG. 4) connected to the gaming devices.

FIGS. 6A, 6B, and 6C are detail diagrams of exemplary types of displays for displaying pattern search information according to embodiments of the invention. The display illustrated in the diagram shown in FIG. 6A includes multiple categories of search parameters that can be set by a player to look for a particular pattern display within a group of gaming devices. The display illustrated in the diagram shown in FIG. 6B includes a list of multiple saved patterns and options to update the saved patterns. The display illustrated in the diagram shown in FIG. 6C includes a game device mapping tool that may be used to locate a game device having pattern display information identified by search parameters entered by a player. Each of the displays illustrated in FIGS. 6A, 6B, and 6C may be included in a search device that is available to a player. As discussed above, these search devices may include wireless devices 130 (FIG. 4), kiosks 140, gaming devices 170, personal computing devices 174, or any other device that is configured to search for pattern display information includes on a plurality of gaming devices. These displays may include touchscreens so that the player may directly interact with the display screen. A player interface panel (not shown) having buttons, switches, or other player input devices may also be present on the search device to manipulate the information presented on the display. Further, although the following illustrated embodiments show certain features for pattern search displays or mapping tools, less features, additional features, or different features may be present on these displays in other embodiments.

Referring to FIG. 6A, a display 320A includes past game information 325, search parameter (option) inputs 330, and soft buttons 390, 395 to access additional option display screens. The past game information 325 may show game performance information from an identified gaming device, game performance information for the player, a representation of the pattern display information from an identified gaming device, or other types of game information. In the illustrated embodiment, the past game information 325 is displaying game information from a gaming device identified using the search parameters 330. That is, the past game information 325 is showing the last 4 of a Kind that was hit on a gaming device identified using the search parameters 330. As FIG. 6A illustrates, the search parameters 330 included in this search display 320A include the type of game to search for, the type of outcome to search for, the pattern style to search for, the physical game location to search for, and any specific search criteria to search for (which may vary depending on the selection of the other search criteria). Here, the player has used the search parameters 330 to specify a search for a video poker machine close to the elevators having a most recent 4 of a Kind hit. The player appears also interested in looking at the trend graph (pattern display information) for the gaming device that is identified using the search parameters 330. As illustrated in FIG. 6A, the last 4 of a Kind may be shown in the past game information 325 for a gaming device identified using the search parameters. The past game information 325 may replace the last 4 of a Kind hand with the trend graph of 4 of Kind hits for the identified gaming device after a predetermined time or in response to a player input. Other embodiments may include additional, less, or different search parameters 330. For example, if a company owns and operates several different casinos, an additional search parameter 330 may let the player search for a gaming device having specific pattern display information at a particular one of the owned casinos, perform the search within multiple ones of the owned casinos (e.g., all owned casinos located in Las Vegas), or perform the search within all of the owned casinos.

The player may also specify less search parameters. For example, the player may simply want to search out the location for all video poker gaming devices, or search for all gaming devices that have a pattern display showing that the game has a less than theoretical hit frequency for the past 24 hours. If more than one gaming device matches the specified search parameters, a list or menu of matching gaming devices may be presented to the player. This list or menu may be displayed in the past game information display area 325 or larger portions of the display screen may be changed to show the list or menu of gaming devices. The player may further refine the list of gaming devices by specifying more search parameters 330 and may browse through the list of gaming devices including viewing their associated pattern display information and other information about the gaming devices, such as game theme, denomination, location, etc.

The pattern search display 320A includes soft buttons 390, 395 that are configured to show alert options (alert button 390) and map options (map button 395). These soft buttons may change the data shown on the display 320A to reflect additional features or options available to the player. For example, the player may selected the alert button 390 to set up preferences for being notified when the display information for other gaming devices substantially matches prior search parameters used by the player. As discussed above, this alert or notification system may run passively to inform the player of pattern display information that may be of interest to them. Additionally, the alert system may be set up by the player to notify them of other gaming device that meet specific search parameters while the player is placing wagers at a gaming device. The player may select the map button 395 when the player has identified one or more gaming devices that they are interested in playing. The map option button may modify the pattern search display 320A to resemble the map display 320C shown in FIG. 6C. However, the map button 395 may be used in other embodiments to print directions to an identified gaming device (such as from a kiosk 210—FIG. 5), or provide audible directions to the player via speakers. The map button 395 may also be used to send directions to a player's cell phone or another mobile device that can be used by the player to locate the identified gaming device.

Referring to FIG. 6B, a display 320B includes a list of saved patterns 350 with associated selection soft buttons 355, a scroll bar 358 configured to allow the list of saved patterns 350 and associated selection buttons 355 to be viewed, and a plurality of update buttons 340 configured to allow the player to modify the list of saved patterns 350. The display 320B also includes a soft button 390 to access an additional option display screen. By providing the player with an option to save desirable patterns, the player may select one of the patterns as a base search pattern in order to identify one or more gaming devices having a substantially similar pattern. This option may be advantageous to a player that has associated good luck with a particular pattern and is looking for a gaming device that has a similar pattern to the one associated with the good luck.

The saved patterns 350 may be patterns that the player chose from a provided list of patterns, patterns that the player created, patterns that the player saved from a gaming device during a gaming session, and/or patterns otherwise chosen by the player. The saved patterns 350 may be associated with a player account such that when a player identifies himself or herself to a search device or gaming device, the player may view previously saved patterns associated with the player's account. The selection buttons 355 may be used by the player to select one of the saved patterns as a base search pattern by which the pattern display information from gaming devices connected to the network will be compared. In some embodiments, the selection buttons 355 may be omitted and the player use a physical button on a player interface (not shown) to select one or more of the patterns. Alternatively, the player may be able to simply touch the desired pattern to select it. The scroll bar 358 may be used to scroll through multiple patterns 350 that do not all fit on the display screen 320B.

The pattern update buttons 340 may include buttons to enter patterns 342, delete patterns 344, and modify patterns 346. These pattern update buttons provide the player with some flexibility in managing what patterns are saved. Although the player may be able to update the saved patterns 350 with these pattern update buttons 340 on the pattern search display 320B, the player may also be able to manage the saved patterns 350 through a personal computer or other computing device the can connect to the network 150 (FIG. 4) and properly identify the player. An alert button 390 may again be included on the display to allow a player to set up alert options for being notified when substantially similar patterns are detected in the pattern display information associated with the plurality of gaming devices connected to the network 150.

Referring to FIG. 6C, a display 320C includes a map screen that displays a present player location 360, and an identified gaming device 365, and a possible route 375 between the player's present position 360 and the identified gaming device 365. The display 320C may also include one or more scroll bars 358 to allow additional parts of the gaming floor to be displayed, and a soft button 370 to return the player to a previous search screen.

The map screen of the display 320C may be used after a player has identified one or more gaming devices that they are interested in locating. The detail and style of the map screen may vary depending on what type of search device has been used by the player to perform the search. For example, if a player conducts a pattern search from a kiosk or gaming device, those search devices will not be able to move with the player and update the player to his or her position relative to the identified gaming device. Hence, map screens for stationary search devices may identify landmarks around the gaming devices to help the player find the gaming device. In the illustrated example, the map screen may identify a bar and waterfall so that a player can easily determine the location of an identified gaming device relative to these landmarks. Additionally, as discussed above, a kiosk printer 240 (FIG. 5) or a ticket printer on a gaming device may be used to print a copy of the map for the player to aid the player in locating the identified gaming device 365.

In another example, the player may be using a wireless search device 250 (FIG. 5) that can accompany the player as they move toward an identified gaming device 365. When using a wireless search device 250, the player's present location 360 may be updated periodically. Thus, as the player moves, the representation of the player's present location 360 may move as well. Additionally, the suggested route 375 may be updated to reflect the player's new location. Alternative routes may also be calculated if the player strays from the originally suggested route 375. For example, in the embodiment illustrated in FIG. 6C, if the player decides to visit the bar shown on the map to get a drink before going to the identified gaming device 365, the suggested route 375 may be recalculated and an alternate route may be shown traveling below the bank of gaming device having the identified gaming device 365.

The scroll bars 358 may be used to view potions of the game floor or casino not shown on the map display 320C. These scroll bars 358 may be especially useful if the player is a long way from the identified gaming device 365 or if multiple game devices are identified in a pattern search that are not similarly located. There may also be additional control device for a player to manipulate the map such as “zoom in” and “zoom out” buttons. If the map screen on the display 320C is accessed through a search screen, the map screen may further include a soft button 370 to return the player to a previous search screen.

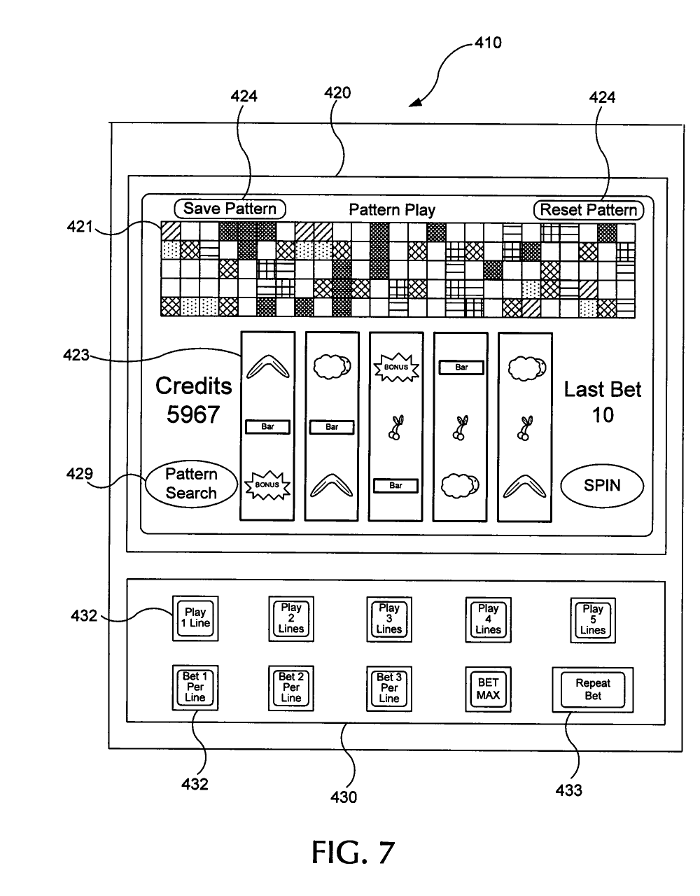

FIG. 7 is a detail diagram of a gaming device according to embodiments of the invention.

Referring to FIG. 7, a gaming device 410 includes a player interface panel 430 and a display 420. Although the gaming device 410 is illustrated as a video slot machine in FIG. 7, the gaming device 410 may be any type of gaming device as discussed above and discussed in the Ser. Nos. 12/398,889 and 12/398,911 applications. Referring to the gaming device 410 illustrated in FIG. 7, the player interface panel 430 may include one or more game buttons 432 and one or more game initiation buttons 433. The display 420 includes a game display 423, a pattern display 421, and player input buttons 421, 424, 429. As previously discussed, the pattern display 421 may show any type of game performance metrics, trend graphs, or patterns.

In this embodiment, a player input button (Pattern Search button) 429 is configured to allow a player to search for other patterns displayed on other gaming devices. This pattern search button 429 may be used by a player that does not like a current pattern shown on the pattern display 421, by a player that has a string of losses on the gaming device 410, or by a player that is looking to play a different gaming device or type of gaming device. By activating this pattern search button 429, the display 420 may change to show a pattern search screen such as the ones shown in FIGS. 6A and 6B. Alternatively, only a portion of the display 420 may change to show pattern search options. For gaming devices that include either of these pattern search tools, a button (not shown) on a pattern search screen may be pressed to cancel the search and/or exit the search screen and return to the game-mode screen on the display 420.

In some embodiments, a save pattern button 424 may be present on the display 420 to allow a player to save a displayed pattern shown on the pattern display 421. For example, a player may want to save a pattern that is present when they hit a large jackpot because they perceive that the displayed pattern is lucky or associated with the jackpot win. The pattern may be saved to a player account associated with the player, emailed to the player, pushed to the Internet, or may be saved to a personal memory device in the possession of the player. In some embodiments, it may be preferable to have the pattern saved to a player account, so that the player can easily retrieve the saved pattern and search for another game device having a similar pattern to one or more of the saved patterns. When a pattern is saved to a player account, the gaming device 410 may send the pattern to a remote server 180 (FIG. 4) over a network 150 to be saved in a database 190 connected to the server 180. The database 190 may be player account database or may be a separate database configured to store saved patterns.

A pattern reset button 424 may also be included on the display and be configured to reset the pattern shown on the pattern display 421. Although the pattern search button 429, patter reset button 424, and pattern save button 424 are shown as soft buttons on the display 420 in this embodiment, they may be configured as physical game buttons 432 or other player-input devices on the gaming device 410 in other embodiments.

In some embodiments, the gaming device 410 may be used to remotely play another gaming device. For example, a player may use the pattern search button 429 to locate another gaming device having a desirable pattern. Instead of requiring the player to find and move to the other gaming device, the present gaming device 410 may allow the player to remotely wager on the identified gaming device or back bet on a player at the identified gaming device. In either situation, the pattern display 421 may be replaced by the pattern display information from the identified gaming device so that the player can monitor changes to the pattern. The game display 423 may also change to reflect the gaming events from the other gaming device. In embodiments where the player is back betting, additional wagering options may be presented to the player on the display 420. For instance, the player may be given the option to simply mirror the other player's bets or may be able to make different wagers on the game event, or even wagers on the other player's performance.

During remote play and back betting, the present gaming device 410 may act as a gaming terminal for the identified gaming device. That is, all game logic and random outcomes are still determined by the identified gaming device. The game events and game outcomes are communicated to the present gaming device 410 through a network 150 (FIG. 4) so that a representation of the events and/or outcomes can be shown on the display 420 of the present gaming device 410. In some embodiments, the wagers made at the present gaming device 410 may influence the pattern being displayed at the identified remote gaming device. This may occur especially where the player is remotely wagering on the identified gaming device since separate gaming events are taking place on the identified gaming device. Hence, game performance data and trends would be updated based on the remote game play. In other embodiments, however, the wagers made at the present gaming device 410 may have no effect on the pattern being displayed at the identified gaming device. These embodiments may preferably include back betting options, since the wagers made from the present gaming device 410 do not cause additional game events or outcomes to be generated at the identified remote gaming device.

FIG. 8 is a flow diagram illustrating methods of identifying a gaming device for a player according to embodiments of the invention.

Referring to FIG. 8, one method of identifying a gaming device for a player includes identifying a player-preferred pattern (810), accessing pattern display information from gaming devices (812), comparing the player-preferred pattern to the accessed pattern display information (814), determining the most similar display from the gaming device displays (816), and notifying the player of a display determined to be the most similar to the player-preferred pattern (818).

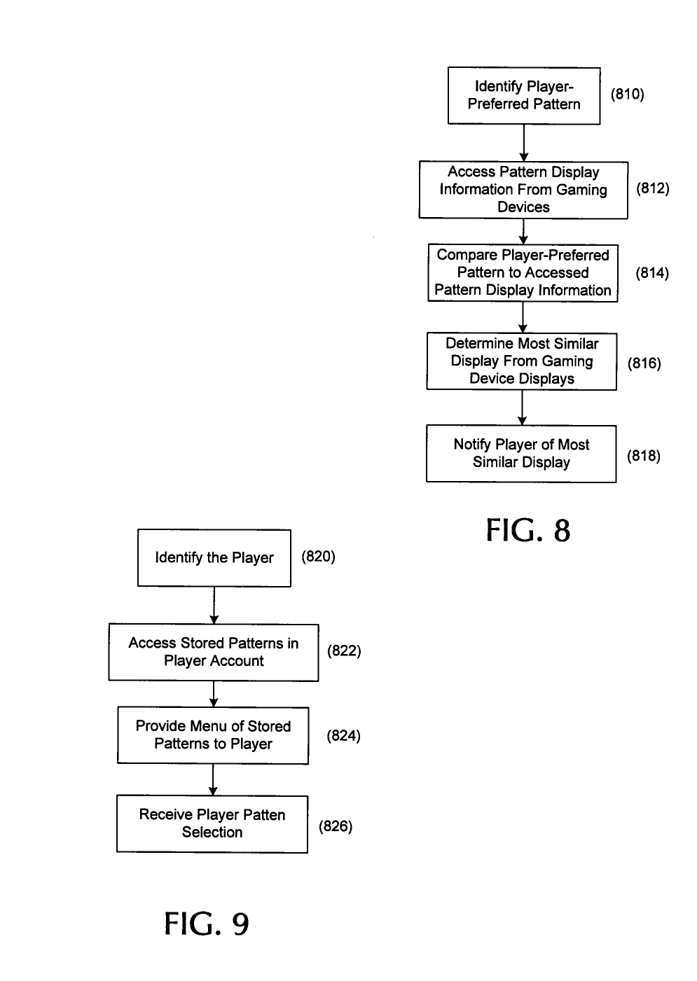

This illustrated method of identifying a game may be used actively by a player to search for a pattern that most closely matches a player specified (preferred) pattern, or it may be used passively to monitor the pattern display information and notify the player if one or more of the displayed patterns substantially match the player preferred pattern. Identifying a player preferred pattern (810) may simply include receiving a player selection of a type of pattern to search for from a list of predetermined patterns provided to the player by the casino. However, if the player is accessing personally stored patterns, identifying the player preferred pattern (810) may include additional steps as illustrated in FIG. 9.

FIG. 9 is a flow diagram illustrating methods of identifying a player-preferred pattern according to embodiments of the invention.

Referring to FIG. 9, one method of identifying a player-preferred pattern includes identifying a player (820), accessing stored patterns in a player account associated with the identified player (822), providing a menu or list of the stored patterns to the player (824), and receiving a selection of one or more of the stored patterns from the player (826). As discussed above, the player may be identified (820) by receiving player identifying information and comparing that received information to player information stored in a connected database of player data. For example, a player may insert a player club card in a card reader to identify himself or herself to the gaming system.

Once a player is identified, a player account may be accessed (822) and any saved patterns associated with the player account may be retrieved from the database. These retrieved patterns may be provided to the player (see e.g., FIG. 6B) as a list or menu from which the player may make a selection of one or more of the patterns (824). Once the player selection is received (826), the selected pattern may be assigned as the player-preferred pattern.

Referring again to FIG. 8, the pattern display information from the gaming devices connected to the gaming server 180 (FIG. 4) via the network 150 are accessed. This may include sending a signal from the gaming server 180 to each of the gaming devices instructing the gaming devices to transmit their corresponding pattern display information to the gaming server. Alternatively, the gaming server 180 may publish the player-preferred pattern to each of connected gaming devices. In either case, once both the player-preferred pattern has been identified and the pattern display information for the plurality of gaming devices is accessed, the player-preferred pattern is compared with the accessed pattern display information (814). Where the gaming devices transmit their respective pattern display information to the gaming server 180, the gaming server 180 may perform this comparison. In embodiments where the gaming server 180 publishes the player-preferred pattern to the gaming devices, each gaming device may perform the comparison.

From the comparison, a most similar pattern display may be determined from the gaming device pattern displays. This determination may be carried out in a variety of manners and may depend largely on the type of pattern being compared. For example, the player-preferred pattern and the accessed patterns may preferably be in the same format so that an accurate comparison can be made. As previously discussed, some patterns or trends can switch between display types, which allows the player to change the type of game performance information being displayed. Here, when a comparison is to be made, either the player-preferred pattern or the accessed pattern information may be modified so that both patterns are in the same format for the comparison.

The most similar displayed pattern may be determined by a point-to-point comparison of the patterns, by a trend line comparison, or by assigning numerical values to the pattern characteristics and comparing these numerical values. Point-to-point comparisons may work the best for random patterns that have a similar layout between a preferred pattern and an accessed pattern. Trend line comparisons may work well for comparing trend graphs and may use a variety of statistical tools to analyze how similar they are. These tools may include using derivative functions to determine slopes of the graph lines, or using integration to determine areas under (or over) specific curves. The assignment of numbers to pattern character parameters for each of the player-preferred pattern and the accessed pattern displays may be especially useful for heat maps or other types of custom created patterns, since the numerical values can be quickly analyzed and manipulated to determine a most similar pattern from the multiple gaming devices.

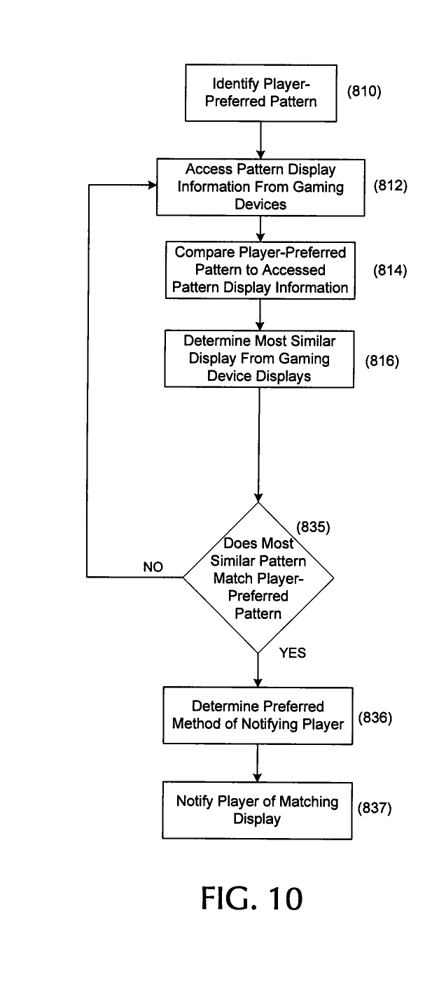

Once the most similar display is determined, the player may be notified of the most similar display (818). In active search modes, the player may be immediately informed of the gaming device having the most similar pattern display. In passive search modes, however, the player may only be notified if the most similar pattern display when the most similar pattern display substantially matches the player-preferred pattern. In other words, the gaming system may not waste time and resources trying to notify the player of a most similar display that is actually not very similar to the player preferred pattern. This additional notification process is illustrated in FIG. 10.

FIG. 10 is a flow diagram illustrating methods of notifying a player of a substantially matching pattern according to embodiments of the invention.

Referring to FIG. 10, the illustrated method of notifying a player of a substantially matching pattern includes identifying a pattern from a plurality of gaming devices that is the most similar to a specified player-preferred pattern, determining if that most similar pattern substantially match the player-preferred pattern (835), determining a preferred method of notifying the player when the most similar pattern does substantially match the player-preferred pattern (836), and notifying the player of the matching display using the preferred method of notification (837).

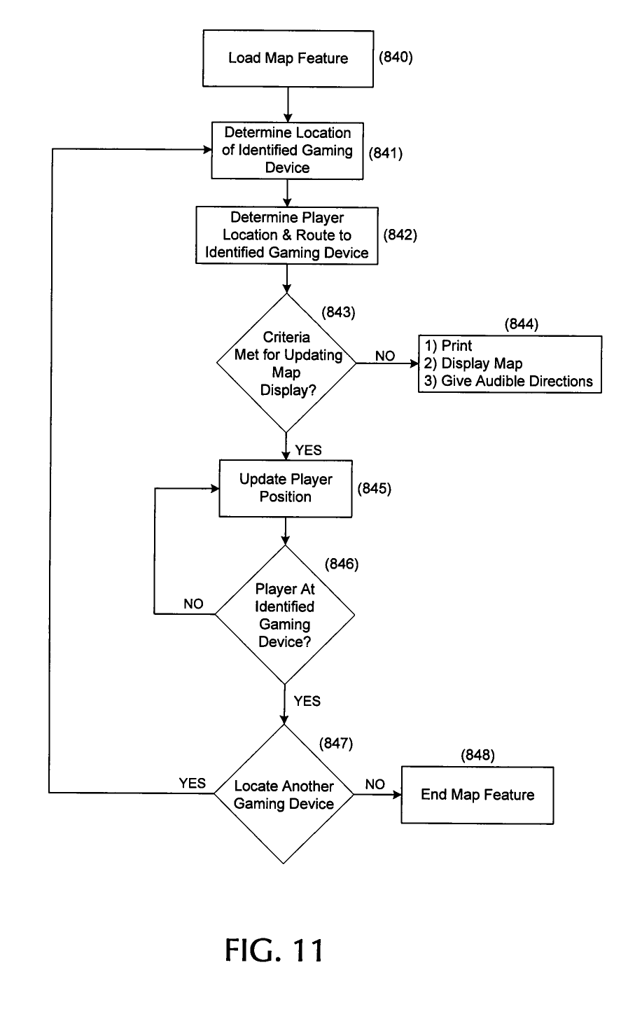

FIG. 11 is a flow diagram illustrating methods of locating an identified gaming device for a player according to embodiments of the invention.

Referring to FIG. 11, this method includes loading a map feature (840), determining a location of the identified or desired gaming device (841), and determining a player's present location and route to the identified gaming device (842). Once these locations have been determined, the system ascertains whether criteria have been met for updating the map display (843). Here, the criteria may simply include whether the search device is stationary or mobile. As discussed above, if the search device is stationary (e.g., kiosk or other gaming device), there is little need to update a player's present location. In this situation, the criteria have not been met and options for providing the route from the player's present location to the identified gaming device may be presented (844). These options may include displaying a map of the game floor to the player, printing a map of the route for the player, or giving the player audible directions.

If the criteria has been met (e.g., the search device is a mobile device in the player's possession), the system may update the player's position (845) and determine if the player is at the identified gaming device (846). If the player is not yet at the identified gaming device, the system may periodically update the player position (845) and determined whether the player has reached the identified gaming device (846). When the player has found the identified gaming device, the map feature may ask the player if they want to locate another gaming device (847) (e.g., when more than one gaming device was identified as matching the player's search parameters). If the player does want to locate another gaming device, the location of the new gaming device is determined (841) and the process repeats itself. If the player is content to play the first identified gaming device, the map feature is ended (848).

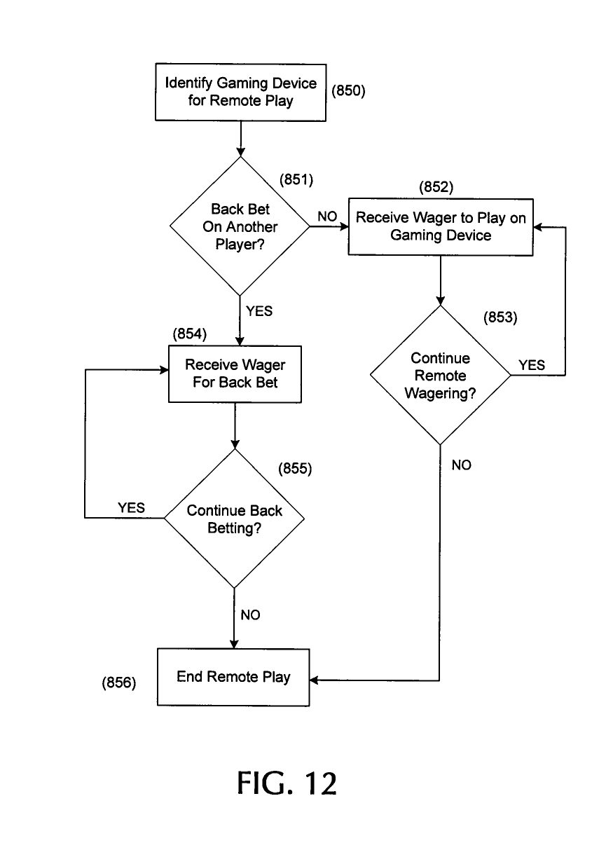

FIG. 12 is a flow diagram illustrating methods of remote wagering on an identified gaming device for a player according to embodiments of the invention.

Referring to FIG. 12, the gaming system first identifies a gaming device that has matched a player's search parameters (850). The system may then determine if another player is playing the gaming device (thereby providing a back betting opportunity) or whether the game device is available for remote wagering (851). If no back betting opportunity exists, the game system may wait to receive a wager from the player to play on the remote gaming device (852) and then determine if the player wants to continue to remotely wager on the gaming device (853). For example, if the player is having luck while wagering remotely, the player may want to find the game device and directly play it. Alternatively, if the player is not having good luck or circumstances necessitate the end of remote wagering, the system may end the remote play session (856).

Returning to the determination of whether back betting is available on the identified gaming device (851), when back betting is available and selected, the a back bet wager is received (854) is received to initiate the back bet. It is then determined if the player wants to continue back betting (855). If so, the player may continue to play back bets (854). However, when the player becomes tired of the back betting or runs into a bad streak of luck, the player may choose to end the back betting (856).

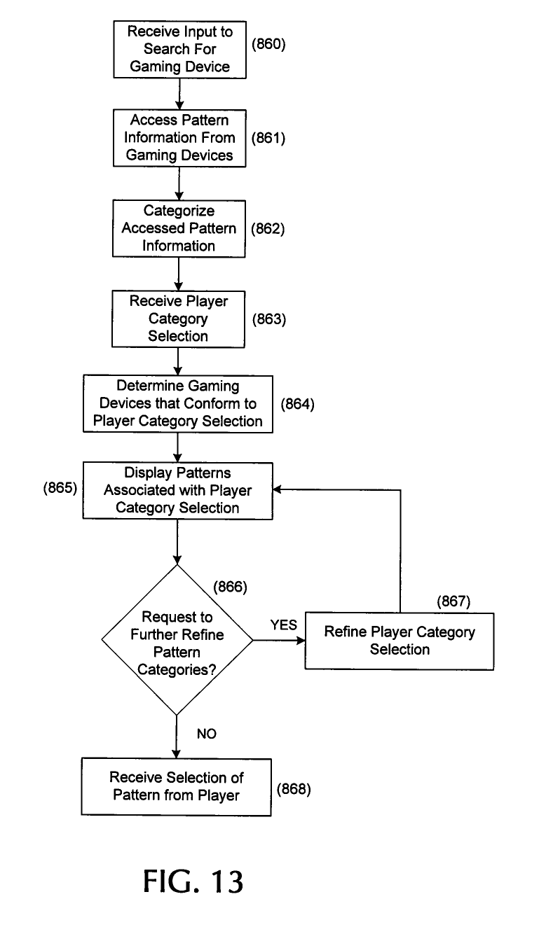

FIG. 13 is a flow diagram illustrating methods of identifying a gaming device for a player according to embodiments of the invention.

Referring to FIG. 13, a method for actively identifying a gaming device using search parameters includes receiving an input to search for a gaming device (860), accessing pattern information for the connected gaming devices (861), and categorizing the accessed pattern display information (862). A player category selection is received (863) and it is determined which of the accessed gaming devices substantially match or conform to the player category selection (864). The gaming devices that do substantially match the player category are listed for the player along with a rendition of the pattern displays associated with the identified gaming devices (865). After these matching patterns are displayed the system determines whether a further pattern refinement has been requested by the player (866). If a refinement has been requested, the player category selection is refined (867) and re-displayed (866). If a further refinement has not been requested, the gaming system waits until a player selects one or more of the patterns to use as a base search pattern (868).

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of identifying a gaming device for a player, the method comprising:
identifying player-preferred pattern display information;
accessing pattern display information for a plurality of gaming devices;
comparing the player-preferred pattern display information to the accessed pattern display information for the gaming devices;
determining a pattern display from the accessed pattern display information associated with the plurality of gaming devices that is most similar to the identified player-preferred pattern display; and
notifying the player of the gaming device having the pattern display that is determined to be the most similar to the identified player-preferred pattern display.

2. The method of claim 1, wherein identifying player-preferred pattern display information comprises:
identifying the player;
accessing a player account associated with the identified player, the player account having stored pattern display information;
providing the player with a menu of the stored pattern display information;
receiving from the player a selection of at least one identified piece of player-preferred pattern display information.

3. The method of claim 2, wherein identifying a player comprises receiving player identifying information from a player account card.

4. The method of claim 2, wherein providing the player with a menu of the stored pattern display information includes providing the player a menu of trend characteristics.

5. The method of claim 2, wherein providing the player with a menu of the stored pattern display information includes providing the player a plurality of pattern images.

6. The method of claim 1, wherein the player is only notified when one or more gaming devices from the plurality of gaming device have pattern display information that substantially matches the player-preferred pattern display.

7. The method of claim 6, further comprising determining a preferred method of contacting the player, and notifying the player via the determined preferred method of contact.

8. The method of claim 1, wherein determining the most similar pattern display includes performing a point-to-point pattern comparison.

9. The method of claim 1, wherein determining the most similar pattern display includes performing a trend line comparison.

10. The method of claim 1, wherein determining the most similar pattern display includes:
assigning numerical values to pattern character parameters of the player-preferred pattern display;
assigning numerical values to pattern character parameters of the respective pattern display information for the plurality of gaming devices;
comparing the assigned numerical values for the player-preferred pattern display and the respective pattern display information from the gaming devices; and
determining the pattern display having the closest numerical value to the numerical value of the player-preferred pattern display.

11. The method of claim 1, further comprising providing the player with information on locating a gaming device having pattern display information that substantially matches the player-preferred pattern display.

12. The method of claim 11, wherein proving the player with information on locating the gaming device includes providing the player with a map of a game floor including a current position of the player and an indication of the location of the gaming device.

13. The method of claim 12, wherein the information provided to the player is provided on a wireless device.

14. The method of claim 13, wherein the information provided to the player on the wireless device updates periodically to show a new current position of the player.

15. The method of claim 12, wherein the information provided to the player is provided on a display at a kiosk.

16. The method of claim 15, wherein the kiosk is further configured to print a copy of the map for the player.

17. The method of claim 11, wherein proving the player with information on locating the gaming device includes providing the player with audible directions to the gaming device.

18. The method of claim 1, further comprising allowing the player to remotely play the gaming device having pattern display information that substantially matches the player-preferred pattern display.

19. The method of claim 18, wherein allowing the player to remotely play the gaming device includes allowing the player to place back-bet wagers on the gaming outcomes of another player playing the gaming device.

20. The method of claim 18, wherein allowing the player to remotely play the gaming device includes allowing the player to place wagers and initiate gaming events on the gaming device.

21. The method of claim 18, wherein the player is allowed to remotely play the gaming device from a wireless device.

22. The method of claim 18, wherein the player is allowed to remotely play the gaming device from another gaming device.

23. The method of claim 18, wherein the player is allowed to remotely play the gaming device from a gaming terminal associated with the gaming device.

24. A method of identifying a gaming device for a player, the method comprising:
receiving an input to search for a gaming device;
accessing pattern display information for a plurality of gaming devices;
categorizing the accessed pattern display information and game characteristics of the respective gaming devices into a plurality of categories;
receiving from the player at least one category selection from the plurality of categories from which to search for a gaming device; and
determining which gaming devices include pattern display information that substantially conforms to the at least one category selection.

25. The method of claim 24, further comprising displaying the pattern display information for the gaming devices having pattern display information substantially conforming to the at least one category selection.

26. The method of claim 24, further comprising displaying a list of gaming devices having pattern display information substantially conforming to the at least one category selection.

27. The method of claim 26, further comprising providing the player a plurality of options to refine the displayed list of gaming devices.

28. The method of claim 27, wherein plurality of refinement options includes options to search for gaming devices on the list by at least one of the group including game denomination, game theme, game location, or game type.

29. The method of claim 27, wherein plurality of refinement options includes options to search for gaming devices on the list by at least one of the group including pattern image type, trend information for game performance, or player performance data.

30. A gaming system comprising:
a plurality of gaming devices having pattern displays;
a server connected to the gaming devices through a network, the server configured to identify display information from the pattern displays of the gaming devices; and
a search device operable by a player to search for desired pattern display information and configured to identify a gaming device having pattern display information displayed that substantially matches the desired pattern display information.

31. The gaming system of claim 30, wherein the search device is a wireless device.

32. The gaming system of claim 30, wherein the search device is a remote kiosk.

33. The gaming system of claim 30, further comprising an internet portal configured to connect the gaming system to the Internet.

34. The gaming system of claim 33, wherein each of the plurality of gaming devices are configured to store images shown on their respective pattern displays to a database, the stored images associated with the player storing the images.

35. The gaming system of claim 34, wherein the server is configured to push the stored images to the Internet through the internet portal in response to a request by the player.

36. The gaming system of claim 34, wherein the stored images on the database are accessible to the player.

37. The gaming system of claim 36, wherein the database is configured to store new patterns, remove old patterns, and modify existing patterns responsive to player commands.

38. The gaming system of claim 30, wherein the search device is associated with a remote gaming device.

39. The gaming system of claim 38, wherein the remote gaming device is configured to allow the player to remotely wager on a gaming device identified by the search device.

40. The gaming system of claim 39, wherein the remote gaming device is configured to allow the player to back bet on another player at a gaming device identified by the search device.
